(19) United States
(12) Patent Application Publication
(10) Pub. No.: US 2009/0254449 A1
(43) Pub. Date: Oct. 8, 2009

(54) ACCESS METHOD OF REGULATORY APPROVING DATA FOR NETWORKED MULTILATERAL ALLIANCE

(75) Inventor: Sachiko KUNO, Potomac, MD (US)

Correspondence Address: HARNESS, DICKEY & PIERCE, P.L.C., P.O. BOX 828, BLOOMFIELD HILLS, MI, 48303, US

(73) Assignee: RUSK Intellectual Reserve AG, Zug (CH)

(21) Appl. No.: 12/483,284

(22) Filed: Jun. 12, 2009

Related U.S. Application Data
(63) Continuation of application No. 10/717,760, filed on Nov. 20, 2003.

(51) Int. Cl. G06Q 30/00; G06Q 50/00; G06F 17/30; G06F 21/20

(52) U.S. Cl. 705/26; 707/104.1; 707/9; 726/3; 707/E17.044

(57) ABSTRACT

The invention achieves certain advantages in pharmaceutical development over large multinational companies by forming a multilateral alliance of independent entities, each with their own geographical focus. In accordance with the invention, a method is provided whereby multiple entities, within the coverage of a common patent portfolio, undertake their own research and development in their own territory. Under a second feature of the invention, the entities may each utilize the information obtained by the others in order to advance their own development program.

### CROSS-REFERENCE TO RELATED APPLICATIONS

The present application claims a priority date of a U.S. provisional patent application No. 60/428,226 filed on Nov. 22, 2002, with a title “METHOD AND SYSTEM FOR A NETWORKED MULTILATERAL ALLIANCE”, which is entirely incorporated by reference into the present patent application.

### BACKGROUND OF THE INVENTION

1) Technical field of the Invention

The present invention relates to a method of doing business for a networked multilateral alliance. In particular, the present invention relates to an access method of regulatory approving data required for regulatory approval of the government and/or the others in the industry such as the pharmaceutical industry where the patent protection of the products is highly appreciated, allowing each of the networked entities resident in a variety of countries to access the regulatory approving data possessed by another networked entity via the network system.

2) Description of Related Arts

In all of the major pharmaceutical markets of the world, a pharmaceutical product requires some form of regulatory approval in advance of marketing. Typically, the regulatory requirements require proof that the pharmaceutical product is safe for a patient and effective to treat the disorder or symptom for which regulatory approval is sought. As illustrated in FIG. 8, the pre-marketing approval process is generally divided into four distinct development phases as follows:

1) Pre-Clinical Testing, which occurs prior to any human testing and establishes proof-of-concept;

2) Phase I Human Testing, which is concerned with evaluating safety;

3) Phase II Human Testing, which seeks to show initial efficacy; and

4) Phase III Human Testing, which seeks to prove statistically significant efficacy.

In the context of the present specification, data and information obtained during the approval process including Pre-Clinical Testing and Phase I-III Human Testings may together be referred to simply as “regulatory approving data”.

Thanks to international efforts made by, for example, the “International Conference on Harmonization of Technical Requirements for Registration of Pharmaceuticals for Human Use,” it has become increasingly possible to use the regulatory approving data developed by one entity in a particular country to obtain another approval in different countries. Thus, to some extent, the regulatory approving data developed in one jurisdiction may have proprietary value in other jurisdictions, even though there are somewhat difference in the schemes or regulations for approval between those jurisdictions.

Meanwhile, a party in pharmaceutical industry such as a pharmaceutical company is, in general, forced to develop such a very expensive and lengthy pre-marketing approval process, costing hundreds of millions of dollars in the US alone, and taking several years to get the pharmaceutical product to market. During the pre-marketing approval process, the pharmaceutical company has to convince investors to finance such developments. Thus, in order to do so, it is essential that the pharmaceutical company has patents in place that will provide an exclusive market position once the product is launched. Thus, the pharmaceutical company should have the patents relating to the pharmaceutical product in all of the jurisdictions where it is to be marketed. In the present specification, the patent is intend to include the granted or issued patent (including utility model) and pending application thereof.

Large pharmaceutical companies typically have the resources to develop pre-marketing approval processes for a pharmaceutical product in multiple countries and regions at one time. However, smaller companies often lack the resources to develop the approval processes for the pharmaceutical product in more than one territory at a time. To this result, the patents owned by the smaller company are likely to be licensed out to the foreign companies that are marketing the product in another jurisdictions (secondary market for the former smaller company) and have the resources to accomplish development of the approval process therein.

Many of licensing tools have been suggested for facilitating a license agreement of various intellectual properties such as a patent. For example, some of the examples are disclosed in the Japanese Patent Publication Application No. 2001-306734 entitled “System and Method for Mediating Contract of Intellectual Property License” and No. 2003-141307 entitled “Intellectual Property Distribution Supporting Method and System Management Server and Program thereof”, which are entirely incorporated by reference into the present patent application. However, those patent publication applications disclose the system and the method for mediating or supporting distribution only of intellectual properties including patents between a possible licensor and licensee. None of the prior arts appreciates the financial value of regulatory approving data and discloses the access method of regulatory approving data so that a foreign company can exploit the data to get another regulatory approval in its jurisdiction.

For instance, a US pharmaceutical company may seek worldwide patents and focus first on obtaining regulatory approval in the US, which is the largest market. Then, the US company may have license agreements for most of the remaining global rights among another foreign companies. Such license agreement may include a co-development clause (optional clause) for data sharing. Thus, according to the optional clause of the license agreement, the licensee may access the regulatory approving data possessed by the licensor with some consideration therefor.

However, those typical license agreements with optional clause have several drawbacks as follows. Thus, they do not provide the licensors with adequate incentives for data sharing. Furthermore, the co-development clause of the license agreements is generally not very flexible because the licensee has no option whether it actually access the data of the licensor and has no pricing mechanism to determine how much compensation is to be paid for data sharing (data access). Also, even if a predetermined amount of the compensation is stated in the agreement, while the licensee actually needs a particular regulatory approving data corresponding to the phase of the pre-marketing approval process, no scheme is available for the licensee to choose it at reasonable price. Thus, the paper agreement cannot provide a flexible pricing mechanism for different types of regulatory approving data in accordance with the various development phases of FIG. 8.

Furthermore, such regulatory approving data is typically confidential information for the company, the licensee may learn whether the licensor has some regulatory approving data, which the licensee could use, mostly during the negotiation of the license agreement. Thus, so far, no searching and accessing tools for regulatory approving data has proposed, allowing a party to find and access desirable data of another party, where both of the parties are not involved in a license agreement. Also, as a person skilled in the art easily imagines, a pile of patents have been issued worldwide for even a single pharmaceutical product, thus, data amount of regulatory approving data corresponding to each of the patents is substantially expanding. Nonetheless, no accessing mechanism is available, which supports any parties without contractual burdens to systematically search and access regulatory approving data relating to each of patents for a particular product.

This accessing mechanism would be advantageous especially for smaller companies inherently effective for focusing on local knowledge and specialization, which yet captures the financial advantages of a large company.

### SUMMARY OF THE INVENTION

Accordingly, one aspect of the present invention provides a new business model under which two or more entities gain financial advantages akin to those of a large company, yet retain the efficiencies of small company operations.

In one aspect, the present invention provides a method of doing business among two or more entities engaged in research and development under the common coverage of a multinational patent portfolio, where each entity has its own territorial distribution of at least some of the patent rights and there is provided a secondary market for certain research and development data and information whereby it can be utilized or purchased by another entity in its territory.

In particular, a first aspect of the present invention include a method of doing business among two or more entities engaged in research and development, wherein the object of said research and development is the subject of a multinational patent portfolio, said method comprising: providing a territorial distribution of at least some of the rights under said patent portfolio and providing a secondary market for regulatory data and information obtained in one entity's research and development whereby it can be utilized by another entity in its territory.

In the first aspect, the secondary market comprises granting certain territorial rights in a entity's regulatory data and information for an amount compensation that may exceed a first entity's cost of development, wherein said compensation comprises royalty payments, the rate of which are proportional the commercial advantage conferred on the second entity when the regulatory data and information is obtained.

In the first aspect, the object of research and development is a pharmaceutical product.

In the first aspect, the territorial distribution of rights is provided by an exclusive territorial license. In one aspect of the present invention, the two or more entities are independent entities.

In the first aspect, the two or more entities comprise three entities.

In a second aspect, the present invention provides a computer implemented method of providing a secondary market for regulatory data and information among two or more entities engaged in research and development where the research and development is the subject of a multinational patent portfolio, comprising: calculating and recording information regarding a territorial distribution of at least some of the rights under said patent portfolio between the two or more entities; developing and storing the regulatory data and information obtained from at least one entity's research and development; and providing a secondary market by which regulatory data and information obtained from one entity's research and development may be utilized by another entity.

In the second aspect, the step of recording information regarding a territorial distribution of the patent portfolio includes recording values related to an agreement among the entities.

In the second aspect, the step of providing a secondary market comprises an entity calculating values associated with the optional right to use the regulatory data and information obtained by the other entities research and development.

In the second aspect, the optional right can be calculated and exercised at different stages of development of the regulatory data and information obtained by the other entities research and development.

In a third aspect, the present invention provides a method for allowing a mutual access of regulatory approving data required for obtaining an approval of a government and/or regulations among a plurality of parties resident in a variety of jurisdictions. The method comprising: providing a server computer including a regulatory database that stores a plurality of regulatory approving data; providing a plurality of client computers connected to the server computer via a communication network, each of the client computers having at least an input and output devices and being assigned to each of the parties; and allowing a first party to access the regulatory approving data in the regulatory database that is possessed by a second party, from the client computer of the first party through the communication network.

In the third aspect, the server computer further includes a patent database storing a patent portfolio having a plurality of patent rights possessed by each of parties; and each of the regulatory approving data is stored in the regulatory database with connection to each of the patent rights.

In the third aspect, the access method further comprises: inputting accessibility information indicating whether the first party can access the regulatory approving data of the second party, from the client computer of the second party to the server computer through the communication network; and storing the accessibility information into the regulatory database with connection to the corresponding regulatory approving data.

In the third aspect, the access method further comprises: inputting a series of compensation conditions for allowing the first party to access the regulatory approving data of the second party, from the client computer of the second party to the server computer through the communication network; and storing the series of compensation conditions into the regulatory database with connection to the corresponding regulatory approving data.

In the third aspect, the series of compensation conditions includes at least one selected from a group consisting of Research and Development Cost, Amount of Lump-Sum Compensation, Ratio of Lump-Sum Compensation, Ratio of Sales Compensation, Amount of Running Compensation, Ratio of Running Compensation, and Ratio of Sales Running Compensation.

In the third aspect, a pre-marketing approval process is divided into a plurality of distinct development phases so that the regulatory approving data includes a plurality of sub-data different based upon the development phase, and at least one of Amount of Lump-Sum Compensation, Ratio of Lump-Sum Compensation, Ratio of Sales Compensation, Amount of Running Compensation, Ratio of Running Compensation, and Ratio of Sales Running Compensation is different based upon the development phase.

In the third aspect, the access method further comprises: inputting an execution instruction from the client computer of the first party to the server computer through the communication network, for obtaining an access right to the regulatory approving data possessed by the second party in consideration of the compensation condition.

In the third aspect, the access method further comprises: licensing at least one of patent rights of the second party stored in the patent database to the first party.

Further scope of applicability of the present invention will become apparent from the detailed description given hereinafter. However it should be understood that the detailed description and specific examples, while indicating preferred examples of the invention, are given by way of illustration only, since various changes and modifications within the sprit and scope of the invention will become apparent to those skilled in the art from this detailed description.

### BRIEF DESCRIPTION OF THE DRAWINGS

The present invention will more fully be understood from the detailed description given hereinafter and accompanying drawings which are given by way of illustration only, and thus are not limitative of the present invention and wherein,

FIG. 1 is a schematic view of a network system realizing an access method of regulatory approving data according to the present invention;

FIG. 2 is a schematic block diagram of a client computer used in the network system of FIG. 1;

FIG. 3 is a schematic block diagram of a regulatory database and a server computer used in the network system of FIG. 1, illustrating several components thereof;

FIG. 4 is a flowchart showing the access method according to the present invention;

FIG. 5 is a view of a display monitor of the client computer when inputting various compensation conditions for accessing regulatory approving data;

FIG. 6 is a view of a screen of the client computer when displaying a series of patents as the result of search by a particular name of the pharmaceutical product;

FIG. 7 is a schematic view illustrating a concept of the business method of the present invention; and

FIG. 8 is a chart showing a typical pre-marketing approval process of the pharmaceutical product.

### DETAILED DESCRIPTION OF THE PREFERRED EMBODIMENTS

The present invention provides a new method of doing business, which is especially adapted to businesses that are subject to heavy government or other regulation and that rely heavily on patent protection, like the pharmaceutical industry. As an example, the pharmaceutical or biotechnology industry in the United States is subject to regulation by the Food and Drug Administration, which must approve all products as safe and effective prior to marketing. The industry relies heavily on patents, which confer an exclusive market position for a limited time that is viewed as essential in recouping the very large development costs incurred in bringing a pharmaceutical product to market. A similar situation exists in most of the major pharmaceutical markets of the world.

In this context, it should be recognized that the pharmaceutical market with government regulation describes one embodiment of the present invention, which will be described herein in detail. One skilled in the art would recognize that other markets where substantial use or testing data (whether required by regulatory authorities or simply for market acceptance) may also use the business model provided by the present invention. Industries such as automobiles, aerospace, waste disposal, nuclear power plants or other environmental impacting industries may require extensive data collection for regulatory (or market) approval prior to full commercial use of a patented invention in these industries. These industries, for example, may also benefit from the business model provided by the present invention. Likewise, with the increasing patentability of computer software worldwide, beta testing or other experimental or use data could also be exchanged using the principles of the business model provided by the present invention. Accordingly, the present invention contemplates the use of the present invention in all such industries and products.

The present invention provides a method of doing business that allows an alliance of smaller companies to operate with some of the financial advantages of large companies, but with the streamlining and efficiency of small companies. In one aspect, the invention creates an operating structure under which two or more companies operate under the same patent portfolio, but in different geographical regions. That is, the patent portfolio (comprising counterpart or related patents and/or applications in multiple geographical jurisdictions or countries) is geographically divided between the two or more entities so that each of the entities has an exclusive right (at least vis-a-vis the other companies) in a particular geographical jurisdiction. Each of the entities undertakes and funds their own development programs, based on business decisions appropriate for business and research goals in their own geographical jurisdictions. However, the present invention provides that these entities also participate in a secondary market under which each entity may sell access to its own regulatory data and information outside its own territory to the other entities. By the same token, each entity may optionally purchase access to the regulatory data and information of the other entity or entities for use in its own territory. This arrangement provide some key advantages to the participants as follows;

### 1) Enhance Efficiency

Research and development is done locally, utilizing local expertise to assure maximum compliance with the local regulatory or other requirements.

### 2) Grow Pipeline

Since each entity can access the regulatory data and information of another entity in their own territory, the research and development pipelines of each entity (or company) extend beyond a entity's own actual development activities. Thus, in addition to their own pipeline products, each entity has “virtual pipeline” products that can be more expediently converted under specified terms to real pipeline products.

### 3) Increase Enterprise Valuation

Because of the access to another entity's pipeline, each entity has additional assets that enhance the value of their business. Hence, financing should be available on more favorable terms.

### 4) Accelerate Development Timelines

When one entity accesses the regulatory data and information of another entity, it obtains a head-start in development.

5) Reduce Development Costs

When an entity allows its regulatory data and information to be accessed, it receives remuneration that defrays, and in some cases may eliminate all, development costs. Furthermore, the development cost associated with independently developing the received data may also be more than the price paid to purchase the received data since the cost of developing the received data is divided among two or more entities.

6) Diversify Risks

Typical smaller companies live or die by the success of one or a small number of products. The virtual pipeline, created by the secondary market gives each entity a hedge against the failure of their own pipeline by expanding the number of products in the pipeline that now includes the virtual pipeline.

In addition, there is a substantial benefit conferred on the patent holder or holders under this model. By licensing different territories to different geographically focused entities that are incentivized to assist one another, the timeline to generating first royalties should be shortened. In this way, the value of a “core technology” embodied in the patent(s) can be maximized.

Thus, the present invention contemplates the existence or formation of a more-or-less typical licensing situation under which territorial patent rights are divided among two or more entities, which may be separate companies (for the sake of convenience, call herein “operating companies”). Actually granting the license is an optional part of the invention, but some form of territorial division of patent rights is needed for optimal performance. The patent rights may be held by one and/or both parties and/or by a third party or multiple third parties (for example, they could part of a patent pool). The patent rights typically would span multiple major markets, with the United States, Europe and Japan being especially important examples for the pharmaceutical market. Using the pharmaceutical example, for optimum working, the patent rights should cover at least two pharmaceutical products or at least two different indications in order to allow the operating companies to pursue their own independent development in their respective territories or markets.

The patent rights generally are divided among the operating companies through some type of license that would allow the operating companies to develop and ultimately market, directly or indirectly through sublicensing, etc., the product(s) in their own territories. The license optimally would have a typical, grant-back or license-back provision that prevents one party from generating a blocking position vis-a-vis the other. The license typically would contain no explicit co-development feature, which allows the individual companies to pursue their own interests for their own reasons and maximizes the efficiencies achieved by the business model provided by the present invention.

The operating companies themselves generally would be smaller companies without the resources to simultaneously pursue pharmaceutical development in multiple major markets, but this is not a requirement. Preferably, the operating companies will be at least functionally independent of one another so that they can pursue their own agendas. However, the operating companies need not necessarily entirely independent and need not even be separate companies (they could be separate divisions of one company), so long as they are given relative autonomy in their own development programs. For instance, they could be subsidiaries of the same parent or commonly controlled by a holding company or a certain group of investors. The exact structure is not as important as the relative autonomy between the operating companies so that they could pursue their research and development in a manner that is optimal for their respective territories.

Under the patent rights, the operating companies proceed with their own geographically (or territorial) focused product development. The decision of whether to develop a particular drug for a particular indication is made independently by each operating company, based on its own business and research considerations. Examples of such considerations include ease of regulatory approval, market size, available funding and price regulation, to name just a few. Each operating company is, or at least functions as, an independent entity, funding and executing their own business plans in accordance with their own interests.

The secondary market, provided by the present invention, for regulatory data and information is based on the ability to share research and development information developed in one jurisdiction in the other jurisdictions. Essentially, each operating company would have an option, but no obligation, in their own territory (or jurisdiction) to access or acquire the regulatory data and information of the other operating company or companies. Such regulatory data and information, includes but is not limited to data and information derived from any or several of the following business activities:
(1) market and business research and intelligence;
(2) research and development of pharmaceutical and medicinal products;
(3) testing of pharmaceutical and medicinal products on human or animal subjects;
(4) obtaining marketing approval for pharmaceutical and medicinal products; and
(5) consultation with respect to any or several of the above activities. The nature of the right acquired in exercising the option is not critical, but it should, for example, give the acquiring party free access to use the regulatory data and information in order to seek regulatory approval. Likewise, in a non-pharmaceutical context, the acquiring party should have free access to the data in order to determine market acceptance or other approval that may be required, including any required regulatory approval. In order to maximize value, the rights hereunder (for example, acquired by exercising the option) generally should be licensable or in some way transferable to third parties by the party obtaining them.

Typically, the remuneration system would comprise one or more fixed payment that may be based, for example, on a percentage of the total cost to produce the regulatory data and information, plus an optional royalty on future sales. The fixed payment(s) helps to defray the actual cost of development incurred by the party selling the regulatory data and information and the royalty allows the selling party to participate in a successful product, potentially reaping many times its cost of development just from revenues generated from the sale of its data and information in this secondary market. The fixed component of payment obviously should be below the cost that the acquiring party would have incurred to obtain the regulatory advantage conferred by the regulatory data and information. The royalty component is generally keyed to the stage of regulatory development, as a reflection of decreased risk from the acquiring party's perspective. The total remuneration usually should take into consideration how the regulatory data and information advances the acquiring party's development program.

Because each operating company undertakes its own development based on its own business decisions, any compensation obtained in the secondary market effectively defrays development costs that would have been incurred in any event. This provides an additional incentive to generate regulatory data and information. Balancing the temptation to merely acquire the regulatory data and information of another party is the fact that the price of acquisition typically increases with the progress of development. Moreover, given the differences in territorial regulatory requirements, one party would almost never be able to completely “piggy-back” on another.

On the part of the operating company acquiring the regulatory data and information in the secondary market, they incur no financial risk until such point as the product has achieved at least some success in advancing toward regulatory approval, reducing the risk of failure. In addition, each operating company has an option in the pipeline of the other operating company or companies, giving them a “virtual pipeline.” Merely exercising these options could, in principle, multiply their pipeline, yet without incurring financial risk until some point at which the probability of success has increased.

In one aspect, the present invention provides that the optimal number of operating companies under such a business arrangement in the pharmaceutical area is three. Thus, the three parties could geographically hold the rights in the three largest pharmaceutical markets—the United States, Japan and Europe. Of course, with the emergence of large markets in other countries in Asia or Latin America, the optimal number of countries would change in order to reflect the relevant market sizes and profitabilities. Thus, each party is sufficiently incentivized by the market rewards in their territory to undertake their own development program.

In the pharmaceutical field, such a business arrangement offers a potential advantage over the current industry model, which is tending towards consolidation into larger and larger multinational companies. Despite their multinational presence, all of those companies typically have a cultural grounding principally in a particular region. While the regulatory approval process has become more universal, there are still very significant differences that require a local focus for optimum results. When a product is developed by an alliance of basically independent entities, as contemplated by the instant invention, each member of the alliance specializes on its own territory, whereas a multinational must focus on all of its territories, yielding less than optimal results from both financial and regulatory perspectives in each of the separate territories.

The following example is presented solely for the purpose of illustrating one embodiment of the present invention. It is merely one aspect of how the invention may work; it is not intended to limit the present invention as would be recognized by those skilled in the art.

### (First Example)

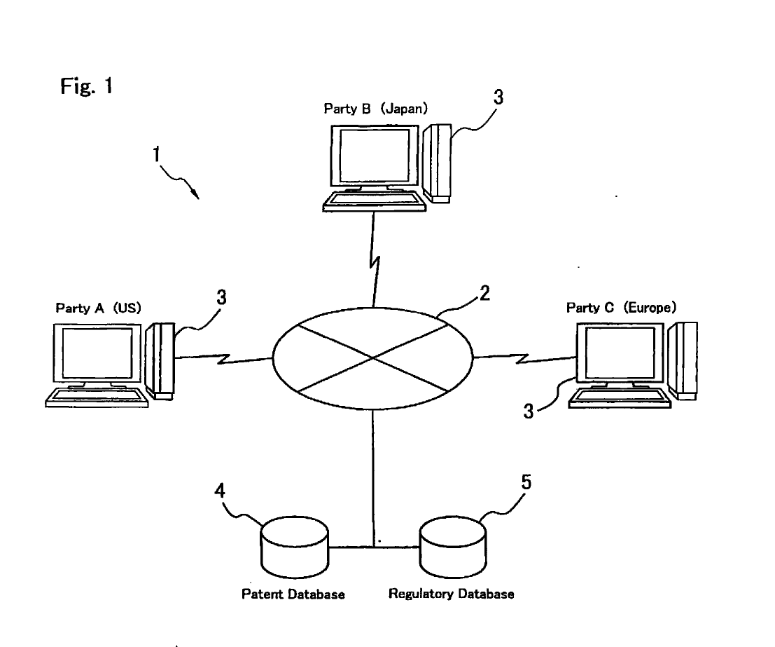

Referring to the attached drawings, the first example of a network system and access method achieved thereby according to the present invention will be described herein. As illustrated in FIG. 1, the network system 1 generally includes a server computer 2 and a plurality of client computers 3 connected via Internet to the server computer 2. Each of the client computers 3 is assigned to the corresponding one of three entities, for example, Parties A, B, C. However, the network system 1 may have client computers 2 more or less than three.

Parties A, B, C may be any forms engaged in research and development of pharmaceutical products such as pharmaceutical companies, colleges, and research institutes, which are resident in the United States, Japan, and Europe, respectively. Also, each of Parties has been working on the development of, for example, an AIDS drug, a lung cancer drug, an obesity drug, and a diabetes drug. As the result of the research and development, each Party obtains a pile of patents relating to those drugs in the United States (preferably including the rest of North and South of America), Japan (preferably including the rest of Asia), and Europe (preferably including the Middle East and/or Africa). When Party is smaller, it is more likely to seek the patent rights solely in its own jurisdiction because of the financial issue. Each of Parties may be companies independent from the others, but may be subsidiary companies relating to each other under a particular multilateral alliance group. The worldwide patents granted to those Parties may be a part of the patent portfolio, which is stored in a patent database 4 of the server computer 2.

Preferably, Parties A, B, C together reach an inclusive patent license agreement so as to practice all patents of the patent portfolio in their own jurisdictions. Thus, according to the inclusive patent license agreement, US Party A is allowed to practice the US patents of Japanese Party B and Europe Party C in the US territory. In other words, each of Parties licenses out own patents to another Party in the secondary market. Therefore, according to the patent license agreement, US Party A grants an inclusive license of own Japanese and European patents to the Japanese and European Parties, respectively.

However, as to the pharmaceutical products, even after the patent license agreement is reached allowing the licensee to practice the patented product, the licensee cannot market them unless and until it obtains the regulatory approval granted by the government or the regulations. Therefore, when the pharmaceutical company is marketing its product, typically, it needs to collect the regulatory approving data through the Pre-Clinical Testing and Phase I-III Human Testings for the pre-marketing approval simultaneously as pursuing the patent right for the core technique at least in its own country. According to the present invention, the regulatory approving data developed by Parties are accumulated with annex of the patent number of the corresponding patent stored in a patent database 4 so as to compose a regulatory database 5 in the server computer 2.

Thus, the server computer 2 includes the patent database 4 accumulating a patent portfolio including all global patents granted to Parties A, B, C, and the regulatory database 5 accumulating regulatory approving data developed by Parties A, B, C for their patents, if any. As will be described herein in detail, one of Parties can easily and instantly access and obtain the desired regulatory approving data relating to a particular patent possessed by another Party.

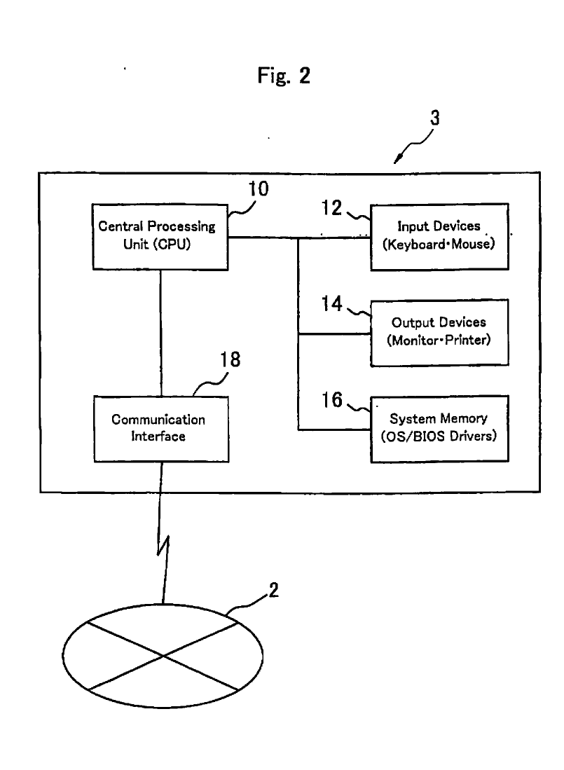

Meantime, as shown in FIG. 2, the client computer 3 includes a central processing unit (CPU) 10, an input device 12 such as a keyboard and mouse, and an output device 14 such as a display monitor and printer. Also, it includes a system memory 16 storing an operating system (OS), a BIOS driver, and an application program. Those components are connected to the central processing unit 10, which is connected to the server computer 2 through Internet and a communication interface 18 such as a modem.

More particularly, each of Parties A, B, C inputs, from the keyboard 14 of the client computer 3, a series of information for each regulatory approving data indicating in part a compensation condition for allowing another Party to access the regulatory approving data as follows. Thus, the series of information include:

1) Accessibility Information indicating whether or not the regulatory approving data obtained and possessed by one Party with connection to the corresponding patent stored in the patent database 4 is accessible for another Party;

2) Research and Development Cost actually incurred for obtaining the regulatory approving data;

3) Amount of Lump-Sum Compensation, which is an up-front monetary amount to be paid as consideration of access to the regulatory approving data;

4) Ratio of Lump-Sum Compensation, where Amount of Lump-Sum Compensation equals to Research and Development Cost multiplied by Ratio of Lump-Sum Compensation;

5) Ratio of Sales Compensation, where Amount of Lump-Sum Compensation equals to Sales Amount (which is monetary sales amount of the product sold by another Party) multiplied by Ratio of Sales Compensation;

6) Amount of Running Compensation, which is a monetary amount to be paid at a regular interval as consideration of access to the regulatory approving data;

7) Ratio of Running Compensation, where Amount of Running Compensation equals to Research and Development Cost multiplied by Ratio of Running Compensation; and

8) Ratio of Sales Running Compensation, where Amount of Running Compensation equals to Sales Amount multiplied by Ratio of Sales Running Compensation.

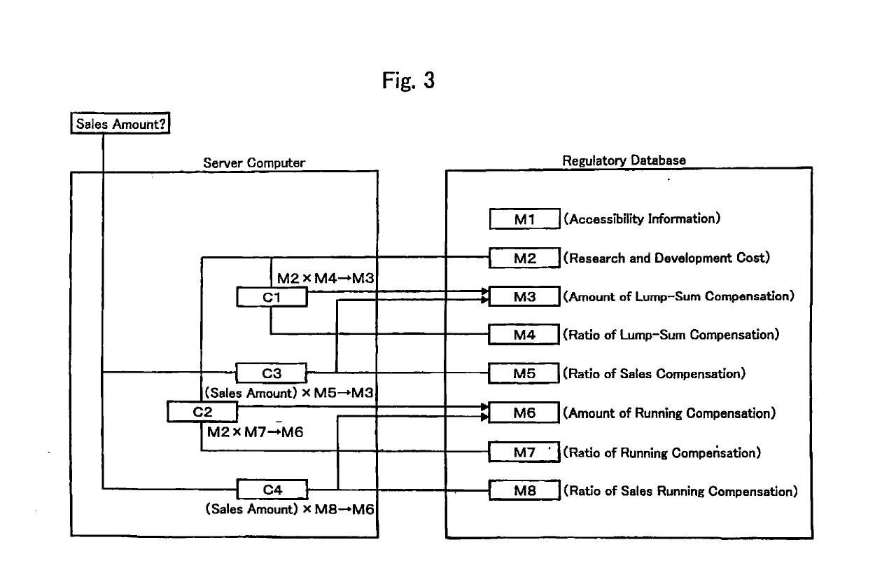

Thus, according to the present invention, as shown in FIG. 3, the regulatory database 5 includes a plurality of storing means, including means for storing Accessibility Information M1, means for storing Research and Development Cost M2, means for storing Amount of Lump-Sum Compensation M3, means for storing Ratio of Lump-Sum Compensation M4, means for storing Ratio of Sales Compensation M5, means for storing Amount of Running Compensation M6, means for storing Ratio of Running Compensation M7, and means for storing Ratio of Sales Running Compensation M8.

Therefore, the series of information is stored in the storing means M1 to M8 of the regulatory database 5 with connection to the corresponding patent stored in the patent database 4.

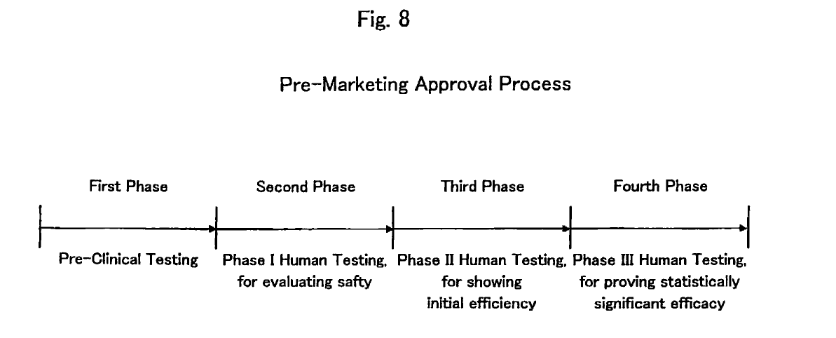

Further, as above, while the pre-marketing approval process is generally divided into four distinct development phases as shown in FIG. 8, the series of information stored in the means M3 to M8 can be varied based upon the development phases. In other words, the means M3 to M8 are capable of storing four different regulatory approving data (values or ratios) in accordance with each of the development phases.

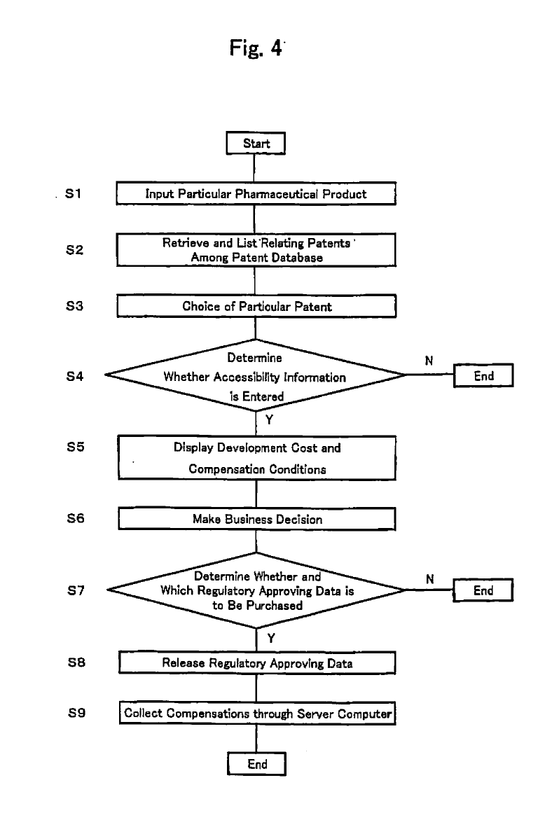

Next, referring to a flowchart of FIG. 4, a exemplary procedure will be described herein, where Japanese Party B is accessing to a particular regulatory approving data for a particular pharmaceutical product.

Before operating the procedure, the aforementioned patent database 4 and regulatory database 5 are structured. Since the patent database 4 may be any forms of patent databases well known to those persons skilled in the art, no further description will be made in detail.

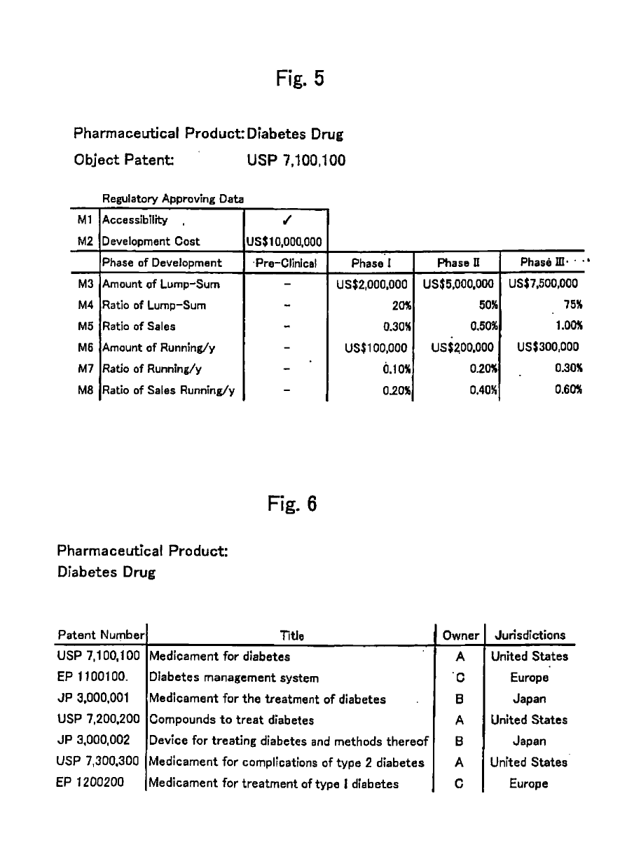

Each of Parties A, B, C inputs the above- mentioned information including various compensation conditions for accessing regulatory approving data with the guidance of the display monitor 14 of the client computer 3 as illustrated in FIG. 5. For example, as to the US. Pat. No. 7,100,100, relating to the diabetes drug, US Party A checks the Accessibility Information on and input the Research and Development Cost (10 million dollars) for one of its patents at the display monitor 14 in FIG. 5. Also, US Party A inputs the compensation condition for allowing another Party to access the regulatory approving data corresponding to the Phase I Human Testing, saying, Amount of Lump-Sum Compensation (2 million dollars), Ratio of Lump-Sum Compensation (20%), Ratio of Sales Compensation (0.3%), Amount of Running Compensation (1 hundred thousand dollars per year), Ratio of Running Compensation (0.1%), and Ratio of Sales Running Compensation (0.2% per year). Further, US Party A inputs the compensation condition for allowing another Party to access the regulatory approving data corresponding to the Phase II and III Human Testings. However, US Party A do not necessarily have to input all of the compensation conditions in some cases, e.g., where no regulatory approving data is available or where US Party A would determine the compensation conditions through a conventional negotiation. Also each of compensation ratios may be preset as a default ratio. Those information including the compensation conditions are uploaded together with the regulatory approving data into the regulatory database 5 and stored in the storing means M1 to M8. The regulatory approving data corresponding to the pre-Clinical Testing and Phase I-III Human Testings are protected to prevent another Party from accessing thereto.

Returning to the flowchart of FIG. 4, at Step S1, Japanese Party B inputs a particular pharmaceutical product (e.g., the diabetes drug) at the input device 12 of the client computer 3. Then, at Step S2, some patents relating to the particular pharmaceutical product, if any, are retrieved among all patents in the patent database 4 and listed at the display monitor 14 of the client computer 3 as shown in FIG. 6.

At Step S3, Japanese Party B chooses one of the listed patents by double-clicking the desired patent. At Step S4, the server computer 2 determines whether or not the Accessibility Information for the chosen patent was input. Then, when determined as being input, at Step S5, the server computer 2 displays the Research and Development Cost and the compensation conditions demanded by the data owner (US Party A) to the display monitor 14 of Japanese Party B. To this end, according to the present invention, Japanese Party B simply refers to the regulatory database 4 without any physical negotiations, so that it can easily and instantly recognize the accessibility of the regulatory approving data possessed by another Party A and the compensation conditions demanded thereby.

Since the governmental approving schemes both in the United States and Japan are similar to each other, the Research and Development Cost actually incurred allows Japanese Party to anticipate the development cost that would be required for individually developing the pharmaceutical product in Japan. Also, when the Amount of Lump-Sum and Running Compensations are input, Japanese Party B immediately learns the amount to be paid to US Party A in consideration of the regulatory approving data. Thus, at Step S6, Japanese Party B makes a business decision with information of the development cost and the compensation amount by balancing two scenarios that it develops the regulatory approving data by itself and that it purchases the data from US Party A. Furthermore, the amount of the compensation is varied based upon each of the development phases, Japanese Party B can make the most efficient and reasonable choice of the development phase to purchase the regulatory approving data.

Meanwhile, Research and Development Cost and Ratio of Lump-Sum Compensation are input, and Amount of Lump-Sum Compensation is not entered, the server computer 2 may use means for calculating Amount of Lump-Sum Compensation (C1) as illustrated in FIG. 3, and display it on the output device 14 of Japanese Party B.

When Amounts both of Lump-Sum and Running Compensation are input by US Party A, Japanese Party B can immediately be noticed how much US Party A demands as the consideration for accessing the regulatory approving data. Although not illustrated, the server computer 2 may calculate the sum of the compensation (Lump-Sum and Running Compensation) within a predetermined period and display it on the display monitor 14 of Japanese Party B.

Also, when Research and Development Cost and Ratio of Running Compensation are input while Amount of Running Compensation is not entered, the server computer 2 may use means for calculating Amount of Running Compensation (C2) as illustrated in FIG. 3, and display it as well.

Further, when Ratio of Sales Compensation and Ratio of Sales Running Compensation are entered, upon receiving an expected Sales Amount of Japanese party B, the server computer 2 may use means for calculating Amount of Sales Compensation (C3, C4) as illustrated in FIG. 3, and display them on the output device 14 of Japanese Party B.

The ability of the regulatory database 5 to store compensation conditions varying in accordance with the development phases allows Japanese Party B to learn the amount of compensation for the desired phase of the regulatory approving data in an instant and precise manner. Thus, when the amount of compensation is dependent upon the development phases, Japanese Party B make the best business decision to optimize the “cost performance” of the particular development phase of the regulatory approving data (sub-data) for the price thereof.

At Step S7, Japanese Party B consider whether and which regulatory approving data is to be purchased. Suppose if Japanese Party B determines to purchase the Phase I of the regulatory approving data with connection to the U.S. Pat. No. 7,100,100. Then, at Step S7, Japanese Party B input an execution instruction from the client computer 3, by clicking an execution icon (not shown) on the display monitor 14, thereby to purchase the access right with consideration indicated as the compensation conditions. At Step S8, the server computer 2 informs US Party A of the fact that the above agreement is reached. Then, US Party A releases the protection for the regulatory approving data and grant the access right solely to Japanese Party B. Simultaneously, at Step S9, US Party A collects the amount of the compensations from Japanese Party B through an accounting mechanism (not illustrated) of the server computer 2. Thus, according to the present invention, the owner of the regulatory approving data can redeem at least a part of the development cost required in developing the regulatory approving data.

### (Second Example)

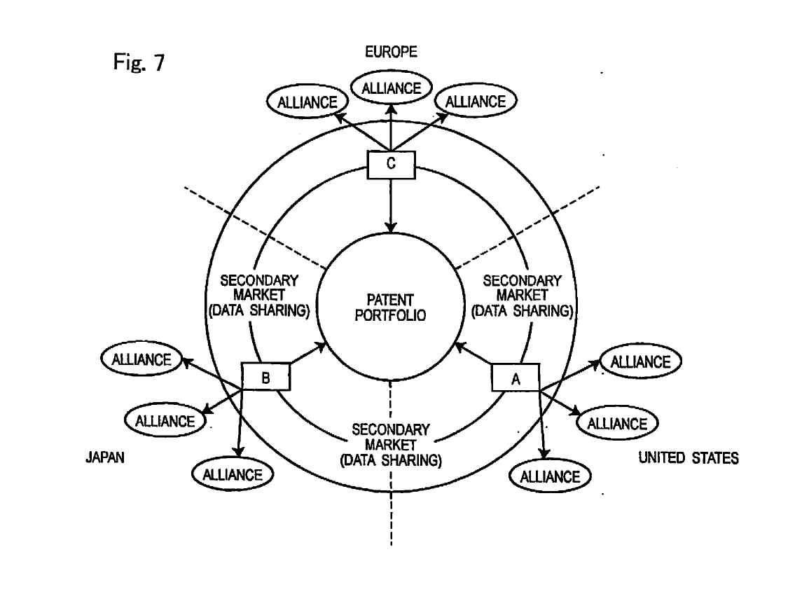

Next, the second example of a network system according to the present invention will be described herein. As shown in generally in FIG. 7, three parties A, B, and C enter into an agreement under which they geographically divide the rights to a patent portfolio that covers pharmaceutical products as above, e.g., an AIDS drug, a lung cancer drug, an obesity drug, and a diabetes drug. Thus, the patent portfolio includes a plurality of patents issued worldwide and assigned to those parties for various pharmaceutical products, and the agreement is such that one of the parties licenses out any one of its foreign patents to the other parties. Further, under the agreement, each of the parties may grant the other parties resident in the foreign countries or jurisdictions, i.e., the secondary market, to access the regulatory approving data thereof for use within the other countries. For example, US Party A provides Japanese Party B and European Party C with access right to the regulatory approving data of US Party A for use within Japan and Europe, respectively. In other words, the regulatory approving data are shared among those parties. The details and procedure of the network system according to the second example are similar to those of the first example, thus, no further description will be duplicated.

Party A decides based on business and regulatory considerations that the obesity drug is the best candidate for US development. Party B decides that diabetes is the best product for Japan and Party C picks lung cancer for Europe. Each party undertakes its own development at its own financial risk based solely on the viability of its business in its own territory. As would be recognized by those skilled in the art, data developed by each party undergoes processing and storage in computing systems that may be interconnected over an electronic network. Each party develops their product from discovery through Phase II clinical testing in their own territory. However, Party C's lung cancer product failed in Phase II trials and is discontinued.

Party A offers its obesity data to Parties B and C in their respective territories. Due to the high degree of similarity between European and US regulatory requirements, Party C can take the data and go directly into Phase III testing, the last phase prior to seeking regulatory approval, and obesity is a substantial European market. As remuneration, for example, Party C pays Party A 50% of the development costs and a 5% royalty on sales in Party C's market. One skilled in the art would recognize, that the transfer of the data from one territory to another involves processing, transformation, and transfer of data from one computing system possibly connected to another through one or more electronic networks.

On the other hand, obesity is a small market in Japan and Party B will still have to do a phase II trial. However, because clinical testing is so much more expensive in Japan than in the US, it would cost Party B nearly 75% of Party A's costs even to develop the obesity drug to the point of entering Phase II trials in Japan. Thus, Party B, for example, agrees to pay 25% of the development costs and a 2% royalty.

Party B offers its AIDS regulatory data and information to the other Parties, but no options are exercised. Party B enters Phase III development for AIDS in Japan.

Party A has effectively subsidized its own research and development through phase II, which it would have undertaken anyway, by 75%. In addition, if European and Japanese products ever reach the market, the 5% and 2% royalty streams potentially could entirely underwrite Party A's entire development.

Party C may have saved its entire enterprise. Although Party C's cancer drug failed, it was able to acquire regulatory data and information sufficient for it to proceed directly into Phase III trials for an obesity drug, the last stage before seeking regulatory approval. Even if Party C needed funding in order to exercise its option, the option itself is an asset that could be leveraged in order to secure financing, perhaps in the form of equity or a licensing transaction.

Party B was able to double its pipeline at a cost well below what it would have taken to get into Phase II itself. Additionally, even though the US regulatory data and information do not allow Party B to advance to Phase III, the fact that Parties A and C are advancing into Phase III gives a higher level of certainty that Party B will too. This could be used to argue for a higher valuation of the obesity project in Party B's market. It should be noted that that Party B incurred absolutely no financing risk in the obesity project until it accessed Party A's regulatory data and information.

At the end of Phase III testing, Party B files a marketing approval application for its AIDS drug. Because of regulatory similarities in the US, the same regulatory data and information may be used to file a new drug application in the US. Party A has insufficient funds to access the data on terms that Party B demands, but is able to directly out-license the AIDS product in the US under terms where the up-front payments (from the licensee(s)) exceed the acquisition costs and the running royalty exceeds the royalty the Party A would have to pay Party B. Party B's AIDS information is entirely unusable in Europe and so no option is exercised.

One skilled in the art would recognize that the above describes a typical computer system connected to an electronic network. It should be appreciated that many other similar configurations are within the abilities of one skilled in the art and it is contemplated that all of these configurations could be used with the method of the present invention. Furthermore, it should be appreciated that it is within the abilities of one skilled in the art to program and configure a computer system to implement the method steps of the present invention, as discussed herein. Furthermore, the present invention contemplates providing computer readable data storage means with program code recorded thereon for implementing the method steps described herein.

1-22. (canceled)

23. A system comprising:
a patent database storing patent data comprising electronic copies of a plurality of patent portfolios, each patent portfolio including at least one patent right relating to a pharmaceutical product, wherein said patent data is provided by a first party and wherein the first party is an owner of said patent rights;
a regulatory data database storing a plurality electronic regulatory data sets relating to the pharmaceutical products, wherein each regulatory data set relates to obtaining regulatory approval to market the product and corresponding and linking to at least one of the patent rights and wherein each of said regulatory data sets is provided by the first party;
a product inquiry module operable to receive a request to obtain preliminary data on a pharmaceutical product from a second party, the preliminary data including the patent data corresponding to said pharmaceutical product;
a display module operable to display at least some of the patent rights corresponding to said requested pharmaceutical product to the second party;
a patent right inquiry module operable to receive a request for a patent right from the second party and operable to retrieve corresponding patent data from said patent database and corresponding regulatory data from said regulatory database;
the display module operable to display compensation condition data relating the regulatory data corresponding to said requested patent right, the compensation condition data being indicative of pricing information;
a patent request module operable to receive a request for purchasing corresponding regulatory data from the second party and to communicate said request to the owner of the patent right; and
an acceptance input module operable to receive a request to release the regulatory data to the second party from the first party.

24. The system of claim 23 wherein the regulatory data includes accessibility data, wherein said accessibility information is indicative of whether said regulatory is accessible to another party and wherein said accessibility data is provided by the first party.

25. The system of claim 24 wherein the patent right inquiry module is further operable to deny a request to the requested patent right or regulatory data when the accessibility information indicates that said requested patent right or regulatory data is not accessible to another party.

26. The system of claim 23 wherein the regulatory data includes compensation condition data representing the first party's conditions for granting access to the regulatory data, the compensation data being communicated to the display module

27. The system of claim 26 wherein the compensation condition data includes lump-sum compensation data wherein said lump-sum compensation data represents an up-front amount that the second party must pay in consideration for access to the requested regulatory data.

28. The system of claim 23 wherein the regulatory data includes data relating to pre-clinical testing of a pharmaceutical product.

29. The system of claim 23 wherein the regulatory data includes data relating to stage one testing of a pharmaceutical product.

30. The system of claim 23 wherein the regulatory data includes data relating to stage two testing of a pharmaceutical product.

31. The system of claim 23 wherein the regulatory data includes data relating to stage three testing of a pharmaceutical product.

32. The system of claim 23 wherein the regulatory data sets include data relating to pre-clinical testing, data relating to stage one testing, data relating to stage two testing and data set relating to stage three testing of a pharmaceutical product.

33. The system of claim 32 further comprising the regulatory data sets including regulatory data sub-sets including a data set relating to pre-clinical testing data, a data set relating to stage one testing data, a data set relating to stage two testing data and a data set relating to stage three testing data, wherein the data sub-sets are individually accessible to a second party and each have corresponding compensation condition data.

34. The system of claim 33 wherein patent purchasing module is further operable to receive requests from a second party for at least one of the regulatory data sub-sets.

35. The system of claim 34 wherein the acceptance input module is further operable to receive a denial request from the first party and to deny access of said regulatory data to the second party.
